(19) United States
(12) Patent Application Publication
(10) Pub. No.: US 2026/0140816 A1
(43) Pub. Date: May 21, 2026

(54) METHOD AND ELECTRONIC DEVICE FOR HANDLING DISRUPTIVE ACTION DURING ANOMALY DETECTION

(71) Applicant: RAPTORXAI PRIVATE LIMITED, Tellapur (IN)

(72) Inventor: Pratyusha Vemuri Venkata, Tellapur (IN)

(21) Appl. No.: 19/119,728

(22) PCT Filed: Dec. 2, 2024
(86) PCT No.: PCT/IN2024/052322

§ 371 Date: Apr. 9, 2025

(30) Foreign Application Priority Data
Dec. 2, 2023 (IN) 202341082127

(51) Int. Cl. G06F 11/07

(52) U.S. Cl. CPC G06F 11/0793; G06F 11/0721; G06F 11/073

(57) ABSTRACT

The present disclosure provides a method for handling a disruptive action during an anomaly detection by an electronic device (100). The method includes monitoring a user activity for a potential fraud attempt using an anomaly detection mechanism. Further, the method includes continuously generating a synthetic data with a self-evolving deception strategy upon monitoring. The strategy is adapted to emerge a threat pattern and introduce an intentional inconsistency to misguide a potential attacker while attempting the potential fraud. Further, the method includes evaluating effectiveness of the strategy in real-time. Further, the method includes providing feedback to the electronic device (100) for adaptive adjustments of the strategy based on the evaluation. Further, the method includes identifying an anomaly based on a comparison between a real time data and the synthetic data. Further, the method includes initiating the disruptive action for autonomously responding to identified anomaly.

### FIELD OF THE INVENTION

The present disclosure relates to a content analysing method and system, and more specifically relates to a method and a system for handling a disruptive action during an anomaly detection using a data driven model (e.g., machine learning model, Artificial intelligence (AI) model or the like).

### BACKGROUND OF THE INVENTION

Information security and sensitivity have become increasingly important due to the growing necessity to detect and prevent violations of policies related to the use, storage, or transmission of sensitive/private information, which has become a major concern in various settings. Additionally, with the rapid increase in digitization, cyber fraud has exponentially risen in various countries. Moreover, to safeguard sensitive/private information, various methods and systems are employed to classify a website and its associated content page, accessed via a uniform resource locator (URL), as fraudulent or genuine. However, existing systems and methods lack the capability to actively disrupt fraudulent activities through the deployment of intelligent and dynamic countermeasures. Hence, there is still a need for an effective method and system to actively disrupt fraudulent activities by deploying intelligent and dynamic countermeasures.

In light of the above-stated discussion, there is a need to overcome the above stated disadvantages.

### OBJECT OF THE DISCLOSURE

A principal object of the present disclosure is to provide a method and a system for handling a disruptive action during an anomaly detection.

Another object of the present disclosure is to monitor a user activity for a potential fraud attempt using an anomaly detection mechanism.

Yet another object of the present disclosure is to continuously generate a synthetic data with a self-evolving deception strategy upon monitoring, where the self-evolving deception strategy is adapted to emerge a threat pattern and introduce an intentional inconsistency to misguide a potential attacker while attempting the potential fraud.

Yet another object of the present disclosure is to evaluate effectiveness of the self-evolving deception strategy in real-time.

Yet another object of the present disclosure is to provide feedback to a dynamic countermeasure controller included in the electronic device for adaptive adjustments of the self-evolving deception strategy based on the evaluation over a period of time.

Yet another object of the present disclosure is to identify an anomaly based on a comparison between a real time data and the synthetic data to initiate the disruptive action for autonomously responding to the identified anomaly.

Yet another object of the present disclosure is to dynamically generate a deceptive element (e.g., fake operating system, fake driver, fake browser history, fake credential or the like) to mislead and misguide a potential attacker (or intruder) upon detection of the potential fraud attempt.

Yet another object of the present disclosure is to generate and deploy an adaptive countermeasure based on a known attack pattern and a detected attack pattern using the generated deceptive element. The adaptive countermeasure provides misinformation and fake results. The misinformation and fake results actively interrupt reconnaissance activities and direct to a decoy and away from original driver or original folder in the electronic device.

### SUMMARY OF THE INVENTION

Accordingly, the present disclosure provides an electronic device for handling a disruptive action during an anomaly detection. The electronic device includes a dynamic countermeasure controller coupled to a processor and a memory. The dynamic countermeasure controller is configured to monitor a user activity for a potential fraud attempt using an anomaly detection mechanism. Further, the dynamic countermeasure controller is configured to continuously generate a synthetic data with a self-evolving deception strategy upon monitoring. The self-evolving deception strategy is adapted to emerge a threat pattern and introduce an intentional inconsistency to misguide a potential attacker while attempting the potential fraud. Further, the dynamic countermeasure controller is configured to evaluate effectiveness of the self-evolving deception strategy in real-time. Further, the dynamic countermeasure controller is configured to provide feedback to the dynamic countermeasure controller for adaptive adjustments of the self-evolving deception strategy based on the evaluation over a period of time. Further, the dynamic countermeasure controller is configured to identify an anomaly based on a comparison between a real time data and the synthetic data. Further, the dynamic countermeasure controller is configured to initiate the disruptive action for autonomously responding to the identified anomaly.

In an embodiment, the self-evolving deception strategy dynamically adjusts the generation of the synthetic data to actively misguide the potential attacker.

In an embodiment, the predefined disruptive action autonomously responds to the identified anomaly using a data driven model. The pre-defined disruptive action corresponds to isolate a suspicious user, block a potentially fraudulent transaction, and dynamically modify access controls to impede malicious activity.

In an embodiment, the potential attacker is misdirected by generating the synthetic data that deliberately introduces inconsistencies and false patterns, and disrupting the attackers'ability to discern normal from the synthetic data.

Accordingly, the present disclosure provides an electronic device for handling a disruptive action during an anomaly detection. The electronic device includes a dynamic countermeasure controller coupled to a processor and a memory. The dynamic countermeasure controller is configured to continuously monitor a user activity for a potential fraud attempt using an anomaly detection mechanism. Further, the dynamic countermeasure controller is configured to dynamically generate a deceptive element to mislead and misguide a potential attacker upon detection of the potential fraud attempt. Further, the dynamic countermeasure controller is configured to generate and deploy an adaptive countermeasure based on a known attack pattern and a detected attack pattern using the generated deceptive element. Further, the dynamic countermeasure controller is configured to generate the disruptive action upon determining a fraud pattern.

In an embodiment, generate the disruptive action upon determining the fraud pattern includes perform at least one of: simulate a potential counter-attack and a response to deter and disrupt the attacker, create a synthetic incident report, where the synthetic incident report includes detailed information on the detected fraud attempt and recommended response action, and generate the response scenario based on the created synthetic incident report, the potential counter-attack and the response to deter and disrupt the attacker.

In an embodiment, the deceptive element is dynamically generated by training a plurality of historical attack data to generate at least one of: a synthetic user profile, a transaction, and a system interaction using a data driven controller, and dynamically generating the deceptive element including at least one of: the synthetic user profile, the transaction, and the system interaction.

In an embodiment, the adaptive countermeasure is generated by training a plurality of historical attack data including a latent variable to simulate potential future attack scenario using a data driven controller, and generating the adaptive countermeasure based on the training over the period of time.

In an embodiment, the disruptive action is generated by training a dataset of fraud patterns and response actions using a data driven controller, identifying a relationship between the detected anomaly and the response actions, and facilitating a generation of disruptive action.

In an embodiment, the potential counter-attack is simulated by training a dataset of known attack patterns using a data driven controller.

In an embodiment, the response to deter and disrupt the attacker is generated by training a plurality of synthetic system vulnerabilities using a data driven controller.

Accordingly, the present disclosure provides a method for handling a disruptive action during an anomaly detection. The method includes monitoring, by an electronic device, a user activity for potential fraud attempt using an anomaly detection mechanism. Further, the method includes continuously generating, by the electronic device, a synthetic data with a self-evolving deception strategy upon monitoring. The self-evolving deception strategy is adapted to emerge a threat pattern and introduce an intentional inconsistency to misguide a potential attacker while attempting the potential fraud. Further, the method includes evaluating, by the electronic device, effectiveness of the self-evolving deception strategy in real-time. Further, the method includes providing, by the electronic device, feedback to the electronic device for adaptive adjustments of the self-evolving deception strategy based on the evaluation over a period of time. Further, the method includes identifying, by the electronic device, an anomaly based on a comparison between a real time data and the synthetic data. Further, the method includes initiating, by the electronic device, the disruptive action for autonomously responding to the identified anomaly.

Accordingly, the present disclosure provides a method for handling a disruptive action during an anomaly detection. The method includes continuously monitoring, by an electronic device, a user activity for a potential fraud attempt using an anomaly detection mechanism. Further, the method includes dynamically generating, by the electronic device, a deceptive element to mislead and misguide a potential attacker upon detection of the potential fraud attempt. Further, the method includes generating and deploying, by the electronic device, an adaptive countermeasure based on a known attack pattern and a detected attack pattern using the generated deceptive element. Further, the method includes generating, by the electronic device, the disruptive action upon determining a fraud pattern.

These and other aspects herein will be better appreciated and understood when considered in conjunction with the following description and the accompanying drawings. It should be understood, however, that the following descriptions are given by way of illustration and not of limitation. Many changes and modifications may be made within the scope of the invention herein without departing from the spirit thereof.

### BRIEF DESCRIPTION OF FIGURES

The invention is illustrated in the accompanying drawings, throughout which like reference letters indicate corresponding parts in the drawings. The invention herein will be better understood from the following description with reference to the drawings, in which:

FIG. 1 shows various hardware components of an electronic device.

FIG. 2 shows various hardware components of a dynamic countermeasure controller included in the electronic device.

FIG. 3, FIG. 4A and FIG. 4B are flow charts illustrating a method for handling a disruptive action during an anomaly detection.

FIG. 5 to FIG. 7 are example illustrations in which the electronic device handles the disruptive action during the anomaly detection.

### DETAILED DESCRIPTION OF THE INVENTION WITH NON-LIMITING EMBODIMENTS AND EXAMPLES

In the following detailed description of the invention, numerous specific details are set forth in order to provide a thorough understanding of the invention. However, it will be obvious to a person skilled in the art that the invention may be practiced with or without these specific details. In other instances, well known methods, procedures and components have not been described in detail so as not to unnecessarily obscure aspects of the invention.

Furthermore, it will be clear that the invention is not limited to these alternatives only. Numerous modifications, changes, variations, substitutions and equivalents will be apparent to those skilled in the art, without parting from the scope of the invention.

The accompanying drawings are used to help easily understand various technical features and it should be understood that the alternatives presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The present disclosure provides a method for handling a disruptive action during an anomaly detection. The method includes monitoring, by an electronic device, a user activity for a potential fraud attempt using an anomaly detection mechanism. Further, the method includes continuously generating, by the electronic device, a synthetic data with a self-evolving deception strategy upon monitoring. The self-evolving deception strategy is adapted to emerge a threat pattern and introduce an intentional inconsistency to misguide a potential attacker while attempting the potential fraud. Further, the method includes evaluating, by the electronic device, effectiveness of the self-evolving deception strategy in real-time. Further, the method includes providing, by the electronic device, feedback to the electronic device for adaptive adjustments of the self-evolving deception strategy based on the evaluation over a period of time. Further, the method includes identifying, by the electronic device, an anomaly based on a comparison between a real time data and the synthetic data. Further, the method includes initiating, by the electronic device, the disruptive action for autonomously responding to the identified anomaly.

Unlike existing methods and systems, based on the proposed method, the electronic device is adaptive to emerging threats, continuously learning from ongoing attacks and updating its deception strategies and countermeasures. This adaptability ensures effectiveness against evolving and sophisticated fraudulent techniques. The electronic device promotes collaboration between organizations by sharing anonymized threat intelligence. This collective intelligence enhances the system's ability to proactively disrupt fraud across industries.

The disruptive anomaly detection system with GANs introduces a ground-breaking approach to fraud prevention by actively engaging in real-time countermeasures. The integration of self-evolving deception strategies, adversarial feedback engine, and the autonomous and adaptive countermeasure engine represents a paradigm shift in not only identifying anomalies but dynamically disrupting them to prevent further harm.

The entire system is adaptive to emerging threats, continuously learning from ongoing attacks, and updating its deception strategies, countermeasures, and decision-making techniques to ensure effectiveness against evolving and sophisticated fraudulent techniques. The system promotes collaboration between organizations by facilitating the sharing of anonymized threat intelligence, thereby enhancing the collective intelligence of the system and proactively disrupting fraud across industries. A deceptive generative engine, an adversarial feedback engine, and an autonomous and adaptive countermeasure engine collaboratively operate in real-time, leveraging collective decision-making for efficient and effective anomaly detection and disruption. The system provides a holistic approach to anomaly detection by actively engaging in real-time countermeasures, disrupting fraudulent activities, and preventing further harm to the system and its users.

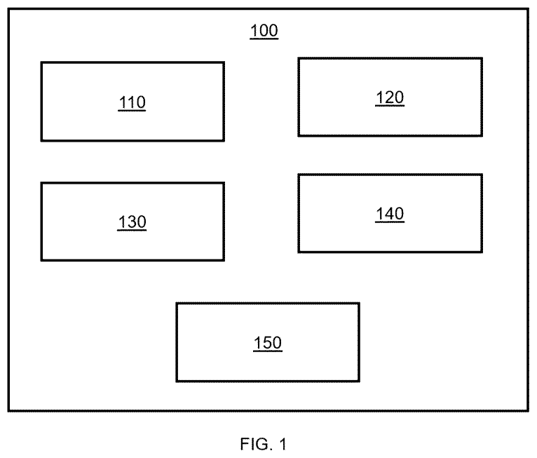

FIG. 1 shows various hardware components of an electronic device (100). The electronic device (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, a server, and an internet of things (IoT) device. The electronic device (100) includes a processor (110), a communicator (120), a memory (130), a dynamic countermeasure controller (140), and a data driven controller (150). In an embodiment, the data driven controller (150) may perform its functions as a separate entity as shown in FIG. 1. In another embodiment, the data driven controller (150) may be comprised in the dynamic countermeasure controller (140). The dynamic countermeasure controller (140) is also called as a dynamic countermeasure system and a dynamic fraud response system. The processor (110) communicates with the communicator (120), the memory (130), the dynamic countermeasure controller (140), and the data driven controller (150).

In general, the dynamic countermeasure controller (140) obtains a data item. The data item includes at least one of a webpage, a website, message, a social media post, and social media comment. Further, the dynamic countermeasure controller (140) analyses a predetermined parameter associated with the data item to identify a fraudulent activity embedded in the data item using a data driven model (e.g., ML model, AI model or the like).

The predetermined parameter can be, for example, but not limited to a content in the data item, user behaviour, network activity, domain of the data item, WHOIS information, lifespan of the domain, an empty Domain Name System (DNS) record, traffic of the data item, a page ranking value, an information of indexing of webpage by a service provider, a number of links pointing to the data item, presence of a host belonging to a top phishing internet service provider, a top phishing domain, an address bar comprising a special symbol, a period of expiry of the domain, a favicon, a preferred status of a port, abnormality based feature, a Hypertext Markup Language (HTML) feature, and a JavaScript based feature.

The abnormality based feature can be, for example, but not limited to a request URL, an anchor associated with the URL, URL, a meta tag, a script tag, a link tag, Server Form Handler (SFH) comprising an empty string, and presence of a mail function. The HTML feature and the JavaScript based feature can be, for example, but not limited to a number of times a webpage redirected to a webpage, status bar customization, a disabled right click feature, a pop-up window with a text field, and an I-frame feature.

After identifying the fraudulent activity embedded in the data item, the dynamic countermeasure controller (140) determines a user activity for a potential fraud attempt using an anomaly detection mechanism. In an example, the dynamic countermeasure controller (140) determines or monitors the user activity while a user (i.e., genuine user) clicking on a malicious link, opening an infected attachment or providing credentials and passwords in a website. For the sake of brevity, the operation of the anomaly detection mechanism is well known in the art. Hence, we are not defining the same operation in the patent disclosure. Upon monitoring, the dynamic countermeasure controller (140) continuously generates a synthetic data with a self-evolving deception strategy. The self-evolving deception strategy is adapted to emerge a threat pattern and introduce an intentional inconsistency to misguide a potential attacker while attempting the potential fraud. Further, the self-evolving deception strategy dynamically adjusts the generation of the synthetic data to actively misguide the potential attacker. The potential attacker is misdirected by generating the synthetic data that deliberately introduces inconsistencies and false patterns, and disrupting the attackers'ability to discern normal from the synthetic data.

For example, in a real credit card data, the user of the electronic device (100) has provided fictional information that resembles what the other user might find on a typical credit card. The credit card data includes the cardholder's name, credit card number, expiration date, CVV, billing address, phone number, and email address. The synthetic credit card data is generated for fraud prevention. Further, the synthetic credit card data is entirely synthetic and does not correspond to any real individual or credit card. It is created for the purpose of training machine learning models and improving fraud detection techniques. The synthetic data mimics the format and structure of real data but does not contain actual, sensitive information. For instance, the credit card number, expiration date, CVV, and other details are randomly generated and do not correspond to any legitimate credit card account. The synthetic data allows organizations to test and refine their fraud detection systems without exposing real customer data to potential risks. The synthetic data serves as a protective measure to enhance cybersecurity and safeguard sensitive information while still enabling the development and improvement of fraud prevention technologies.

For example, below are the real credit card data (Fictional):
Cardholder Name: John Smith
Credit Card Number: 1234-5678-9012-3456
Expiration Date: 12/25
CVV (Card Verification Value): 123
Billing Address: 123 Main Street, Anytown, USA
Phone Number: (555) 123-4567
Email Address: john. smith@email. com

For example, below are the synthetic credit card data (Generated for Fraud Prevention):
Cardholder Name: Alice Johnson
Credit Card Number: 5678-9012-3456-7890 (Synthetic and not real)
Expiration Date: 06/26 (Synthetic and not real)
CVV (Card Verification Value): 789 (Synthetic and not real)
Billing Address: 456 Elm Avenue, Other city, Country (Synthetic and not real)
Phone Number: (555) 987-6543 (Synthetic and not real)
Email Address: alice. johnson@email. com (Synthetic and not real)

Similarly, the synthetic data is generated for various other information such as Login Credentials, Personal Identifiable Information (PII), Transaction Details, Communication Logs, Device Information and Financial Records. The PII such as social security numbers, can be used for identity theft, fraudulent loan applications, and other illicit activities. By using the transaction details, the fraudsters may look for transaction data to identify patterns, conduct card-not-present fraud, or exploit weaknesses in the payment system. By using the communication Logs, the attackers may seek email and messaging logs to identify sensitive information or leverage communications for social engineering attacks. The device information, such as IP addresses and device identifiers can be used to trace the location of users or devices and potentially compromise their security. By using the financial records, the transaction history and credit scores may be targeted to gain insights into an individual's financial health or to facilitate fraudulent financial activities.

Further, the dynamic countermeasure controller (140) evaluates effectiveness of the self-evolving deception strategy in real-time. Based on the evaluation over a period of time, the dynamic countermeasure controller (140) provides feedback to the dynamic countermeasure controller (140) for adaptive adjustments of the self-evolving deception strategy.

Further, the dynamic countermeasure controller (140) identifies an anomaly based on a comparison between a real time data and the synthetic data. Further, the dynamic countermeasure controller (140) initiates the disruptive action for autonomously responding to the identified anomaly. The predefined disruptive action autonomously responds to the identified anomaly using the data driven controller (150). The pre-defined disruptive action corresponds to isolate a suspicious user, block a potentially fraudulent transaction, and dynamically modify access controls to impede malicious activity.

In an example, the organization uses the synthetic data to establish a baseline of normal network traffic and employs an autonomous countermeasure to detect anomalies in real-time network activity. When a significant deviation from the normal behaviour is identified, the electronic device (100) autonomously responds by initiating a disruptive action, ultimately preventing potential security threats to a network.

The use of synthetic data in anomaly detection serves several important purposes, even when deviations in regular data can be detected. Here are some key reasons why the synthetic data is valuable in anomaly detection:
1. Establishing a Baseline: The synthetic data helps create a baseline of normal behaviour and patterns. While deviations in regular data can be detected, having a clear understanding of what constitutes normal behaviour is crucial. The synthetic data provides a reference point against which deviations can be measured. This helps the system distinguish between normal variations and potentially malicious anomalies.
2. Adaptability to Emerging Threats: The synthetic data can be continually updated and adapted to reflect evolving user behaviours and attack techniques. As new threats emerge, the synthetic data can be modified to include these patterns, ensuring that the system remains effective in detecting novel and sophisticated attacks.
3. Reducing False Positives: By incorporating the synthetic data, the electronic device (100) can be trained to recognize expected variations in user behaviour. This reduces the likelihood of generating false positive alerts for benign deviations, such as changes in user habits or network traffic patterns due to legitimate reasons.
4. Enhanced Privacy and Security: In some cases, using real user data for training and testing models can raise privacy and security concerns. Synthetic data can be generated to mimic the characteristics of real data while ensuring that sensitive information is not exposed.
5. Testing and Validation: The synthetic data is useful for testing and validating the effectiveness of anomaly detection models and countermeasures in a controlled environment. It allows organizations to simulate various scenarios, including rare and extreme ones, to assess how well the system responds.
6. Continual Learning and Improvement: The synthetic data can be used to train machine learning models that continually learn and adapt to evolving threats. The models can use synthetic data as a training resource, enabling them to identify new patterns and anomalies as they emerge.
7. Response Preparation: The synthetic data can assist in simulating potential threats and response scenarios. Organizations can use it to train their incident response teams and assess the effectiveness of their response plans without exposing real data to risk.

In short, while deviations in regular data can indeed be used to detect anomalies, the synthetic data plays a crucial role in improving the accuracy, adaptability, and robustness of anomaly detection systems. It helps reduce false positives, enhances privacy and security, and enables organizations to stay ahead of evolving threats. The synthetic data is a valuable tool in the arsenal of cybersecurity and fraud prevention.

In another example, consider following scenario. A cybersecurity company is using the synthetic data for anomaly detection and prevention in its network security system. The organization has deployed the dynamic countermeasure controller (140) capable of autonomously responding to anomalies detected during network traffic analysis. In order to perform the unauthorized network access detection, the following parameter is considered as example such as
1. Normal Network Traffic: In normal circumstances, legitimate users and devices interact with the company's network. These interactions include data transfers, requests, and communication between devices.
2. Synthetic Data Integration: The synthetic data, which mimics typical network traffic patterns and user behaviours, is integrated into the network security system. It includes synthetic device profiles, traffic records, and communication patterns.
3. Real-time Network Traffic Analysis: The network security system continuously monitors incoming and outgoing network traffic in real-time. It analyses data packets, connection requests, and device behaviour.
4. Comparison with Synthetic Data: As network traffic occurs, the system simultaneously compares the observed traffic with the synthetic data profiles and network activity records. The comparison involves checking whether the traffic aligns with the typical behaviour seen in the synthetic data or if there are deviations.
5. Detection of Anomaly: An anomaly is detected when the system identifies a significant deviation between the real-time network traffic and the synthetic data profiles. For example, if a device known for sending small data packets suddenly starts transferring a large volume of data, it triggers an anomaly alert.
6. Autonomous Response Triggered: The detection of the anomaly automatically triggers the autonomous countermeasure agent. The agent is responsible for responding to such anomalies in real-time.
7. Disruptive Action Initiation: The autonomous countermeasure agent initiates a disruptive action, which may include isolating the suspicious device, blocking the network connection, or raising security alarms. In an example, the agent could quarantine the device, preventing further network communication until the anomaly is resolved.
8. Security Team Notification: Simultaneously, the security team is alerted about the anomaly. They receive information about the device, the nature of the detected anomaly, and the time of the event.
9. Incident Investigation: The security team begins investigating the incident to determine its cause and potential impact. They analyse the network traffic data and assess whether it was a legitimate anomaly or a security breach.
10. Resolution and User Interaction: Depending on the investigation's findings, the security team takes appropriate actions. If it was a false positive, they release the device from quarantine. If it's a genuine security threat, they follow incident response procedures.
11. Logging and Learning: The incident is logged for auditing and learning purposes. It contributes to the organization's understanding of emerging network threats and helps improve the synthetic data models and countermeasure responses.

In another embodiment, the dynamic countermeasure controller (140) continuously monitors the user activity for the potential fraud attempt using the anomaly detection mechanism. Further, the dynamic countermeasure controller (140) dynamically generates a deceptive element to mislead and misguide a potential attacker upon detection of the potential fraud attempt. The deceptive element can be, for example, but not limited to a fake operating system, a fake driver, a fake browser history, a fake credential or the like. In an embodiment, the deceptive element is dynamically generated by training a plurality of historical attack data to generate at least one of: a synthetic user profile, a transaction, and a system interaction using a data driven controller (150), and dynamically generating the deceptive element comprising at least one of: the synthetic user profile, the transaction, and the system interaction.

Further, the dynamic countermeasure controller (140) generates and deploys the adaptive countermeasure based on a known attack pattern and a detected attack pattern using the generated deceptive element. The adaptive countermeasure provides misinformation and fake results. The misinformation and fake results actively interrupt reconnaissance activities and direct to a decoy and away from original driver or original folder in the electronic device (100). In an embodiment, the adaptive countermeasure is generated by training the plurality of historical attack data including a latent variable to simulate potential future attack scenario using the data driven controller (150) and latent variable analysis techniques, and generating the adaptive countermeasure based on the training over the period of time.

The latent variable analysis techniques, such as probabilistic graphical models or deep learning models, are applied to the pre-processed data. These techniques uncover hidden patterns, behaviours, or characteristics of cyberattacks that are not apparent from the explicit data. The latent variable serves as a representation of these hidden aspects. Consider an example, where historical attack data includes network traffic logs. These logs contain information about connection attempts, data transfer rates, and communication patterns. Through latent variable analysis, the system identifies a latent variable related to “stealthy reconnaissance behaviour”. The latent variable represents subtle, hidden patterns in network traffic that indicate reconnaissance activities by potential attackers. Adaptive countermeasures, such as enhanced monitoring of specific network segments and dynamic traffic analysis, are generated based on the latent variable's presence.

Below are few examples related to the use of Generative Adversarial Networks (GANs) for anomaly detection, specifically focusing on how latent variables and synthetic data can enhance the detection of anomalies:

### Scenario 1: Network Intrusion Detection:

1. Data Source: Network traffic logs, including packet headers, connection timestamps, and data payloads.
2. Latent Variable: A latent variable capturing “stealthy reconnaissance” behaviours is discovered. This latent variable represents subtle patterns in network traffic indicative of reconnaissance activities by potential attackers.
3. Synthetic Data Generation: The synthetic network traffic data is generated based on the latent variable. It introduces inconsistencies and false patterns into the data, making reconnaissance activities less distinguishable from normal traffic.
4. Anomaly Detection: The electronic device (100) compares real-time network traffic to the synthetic data, identifying anomalies that deviate from the learned normal behaviour, including stealthy reconnaissance attempts.

### Scenario 2: Credit Card Fraud Detection: in a Credit Card Fraud Detection System Utilizing GANs:

1. Data Source: Credit card transaction logs, including transaction amounts, merchant information, and user account details.
2. Latent Variable: The latent variable representing “suspicious transaction behaviour” is identified. This latent variable captures hidden patterns in transaction data associated with fraudulent activities, such as unusual spending patterns or high-value transactions.
3. Synthetic Data Generation: The Synthetic credit card transaction data is created based on the latent variable. It introduces inconsistencies and false patterns into the data, making fraudulent transactions less distinguishable from legitimate ones.
4. Anomaly Detection: The electronic device (100) compares real-time credit card transactions to the synthetic data, identifying anomalies that deviate from the learned normal behaviour, including suspicious transactions.
   Scenario 3: Insider Threat Detection. In an Insider Threat Detection System Incorporating GANs:
1. Data Source: The user activity logs, including file access, login times, and data transfers.
2. Latent Variable: The latent variable associated with “unusual data access” is revealed. This latent variable characterizes hidden behaviours, such as unauthorized file downloads or access to confidential data, indicative of insider threats.
3. Synthetic Data Generation: The synthetic user activity logs are generated based on the latent variable. They introduce inconsistencies and false patterns into the data, making insider threats less distinguishable from regular user activities.
4. Anomaly Detection: The electronic device (100) compares real-time user activities to the synthetic data, identifying anomalies that deviate from the learned normal behaviour, including insider threat indicators.
   Scenario 4: Healthcare Anomaly Detection. In a Healthcare System Using GANs for Anomaly Detection:
1. Data Source: Electronic health records, including patient vitals, medical diagnoses, and treatment history.
2. Latent Variable: A latent variable related to “uncommon treatment patterns” is detected. This latent variable captures hidden patterns in medical records associated with unusual or potentially harmful treatment practices.
3. Synthetic Data Generation: Synthetic healthcare records are generated based on the latent variable. They introduce inconsistencies and false patterns into the data, making unusual treatment practices less distinguishable from standard medical procedures.
4. Anomaly Detection: The electronic device (100) compares real-time patient records to the synthetic data, identifying anomalies that deviate from the learned normal behaviour, including uncommon treatment patterns.

By incorporating synthetic data generated from the latent variables, the electronic device (100) can effectively identify deviations from normal behaviour and enhance the detection of anomalies, ultimately improving security and threat detection mechanisms.

Further, the dynamic countermeasure controller (140) generates the disruptive action upon determining the fraud pattern. In an embodiment, the disruptive action is generated by training a dataset of fraud patterns and response actions using the data driven controller (150), identifying a relationship between the detected anomaly and the response actions, and facilitating the generation of disruptive action.

In an embodiment, the dynamic countermeasure controller (140) performs at least one of: simulate a potential counter-attack and a response to deter and disrupt the attacker. Further, the dynamic countermeasure controller (140) creates a synthetic incident report. The synthetic incident report includes detailed information on the detected fraud attempt and recommended response action. Further, the dynamic countermeasure controller (140) generates the response scenario based on the created synthetic incident report, the potential counter-attack and the response to deter and disrupt the attacker. In an embodiment, the potential counter-attack is simulated by training a dataset of known attack patterns using the data driven controller (150). In an embodiment, the response to deter and disrupt the attacker is generated by training a plurality of synthetic system vulnerabilities using the data driven controller (150).

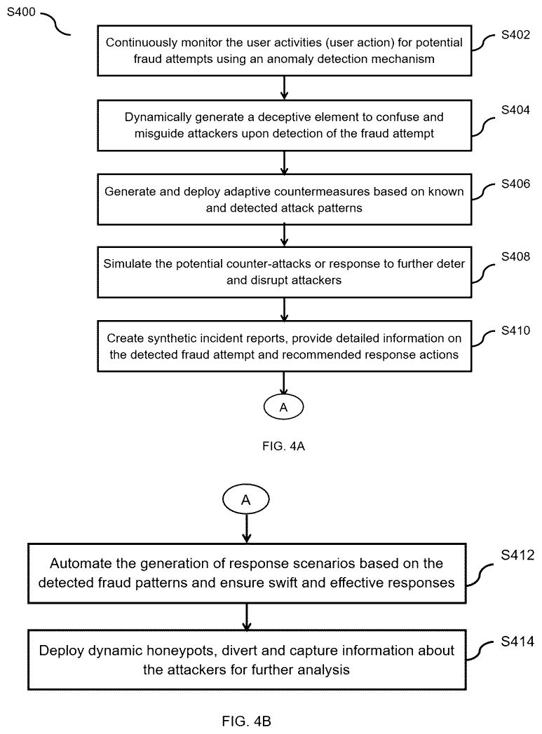

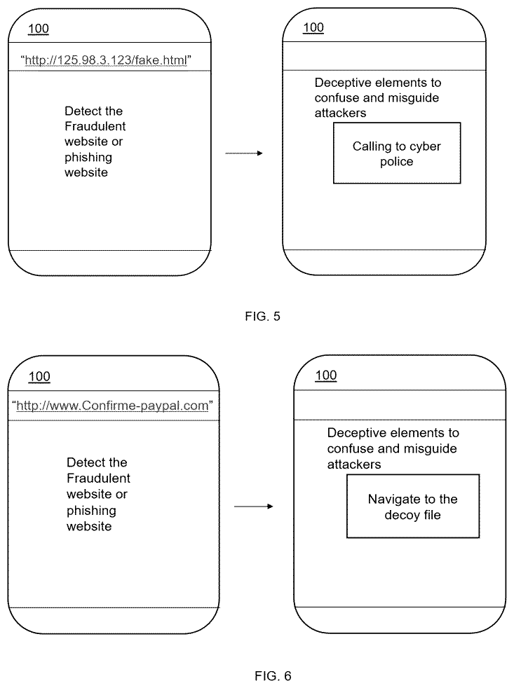

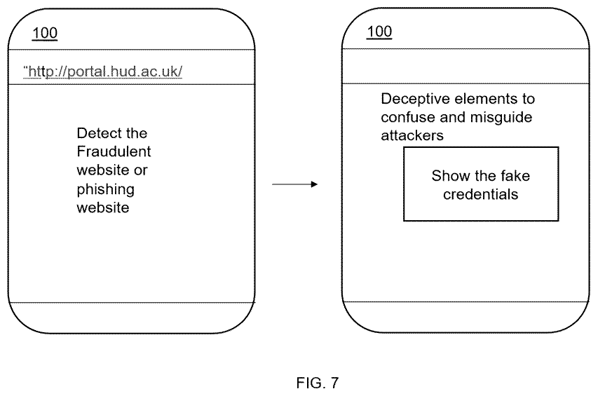

In an example, the electronic device (100) handles the disruptive action during the anomaly detection are shown in FIG. 5 to FIG. 7. In FIG. 5, the deceptive element will be “calling to cyber police” while accessing the data item (i.e., “http://125.98.3.123/fake. html”). In FIG. 6, the deceptive element will be “navigate to the decoy file” while accessing the data item (i.e., “http://www.Confirme-paypal.com”). In FIG. 7, the deceptive element will be “Show the fake credentials” while accessing the data item (i.e., “http://portal.hud.ac.uk/).

Below is an example that shows how the synthetic data can be used for active misdirection with respect to a banking system:
1. Initial Suspicion: A fraudster logs in with the real data, and the bank's system initially detects this login attempt as suspicious based on known patterns of fraudulent activity.
2. Synthetic Data Generation: In response to the suspicious login attempt, the bank's system generates the synthetic data internally as part of its security measures. The synthetic data includes a fabricated set of recent transactions in the account.
3. Fraudster's Second Attempt: Unaware of the synthetic data's generation, the fraudster, thinking they are using real credentials, attempts another login, now using the same real credentials as before (e.g., the same username and password).
4. Detection Based on Real Data: When the fraudster attempts the login using the same real credentials they used initially, the bank's system detects this login attempt as suspicious based on the known fraudulent activity associated with those credentials.
5. Misdirection with Synthetic Data: While the system has detected the login attempt based on real data as suspicious, it also simultaneously introduces the synthetic data into the fraudster's account. For example, the system displays the fabricated recent transactions, making it appear as if the fraudulent transactions they initiated earlier have already been completed.
6. Fraudster's Interaction with Synthetic Data: The fraudster, thinking they have successfully logged in with real credentials, may review the synthetic recent transactions. Seeing the fabricated transactions, they may believe that their fraudulent actions have already gone through.
7. Continued Monitoring and Response: The bank's system continues to monitor the fraudster's actions, including their interaction with the synthetic data. If the fraudster attempts any further actions (e.g., additional transactions), the system can detect these actions as suspicious and take appropriate measures.

In this scenario, the synthetic data (fabricated transactions) is used to misdirect the fraudster by making them believe that their fraudulent actions have already taken place. This can create confusion and may make the fraudster more easily identifiable as they continue to interact with the system.

Below example is explained for active misdirection in an email security:
1. Phishing Attack Attempt: A cybercriminal attempts the phishing attack by sending fraudulent emails to employees within a company. The emails contain links to a fake login page designed to steal credentials.
2. Synthetic Data Generation: In response to the phishing attempt, the company's email security system generates synthetic login pages that mimic the appearance of the real ones.
3. Active Misdirection: Instead of allowing the phishing links to reach the actual fake login page, the email security system dynamically modifies the links to redirect the attacker to the synthetic login pages.
4. Attacker Interaction: Unaware of the active misdirection, the attacker interacts with the synthetic login pages, believing they are on the genuine site.
5. Detection and Analysis: The email security system closely monitors the attacker's actions within the synthetic environment. Any suspicious behaviour or login attempts are flagged for analysis.
6. Countermeasures and Reporting: Based on the attacker's interaction with the synthetic data, the security team can take countermeasures, such as blocking the attacker's IP address, strengthening email filters, and reporting the incident.
7. Enhanced Security: The insights gained from the attacker's actions are used to enhance email security measures and educate employees about phishing threats.

In this above simplified example, the synthetic data is used to actively misdirect the phishing attacker to controlled login pages, allowing the security team to monitor the attacker's activities and take appropriate actions. The goal is to both thwart the attacker's attempts and gather intelligence for improved cybersecurity.

Below example is explained for active misdirection in a website security:
1. Initial Attack: A malicious actor attempts to exploit vulnerabilities in a company's website by launching a SQL injection attack. They aim to gain unauthorized access to sensitive customer data stored in the company's database.
2. Detection of Attack: The company's web application firewall and intrusion detection system detect the SQL injection attempt and flag it as a potential security threat. The security team is alerted.
3. Synthetic Data Generation: In response to the attack, the company's security system generates synthetic customer profiles and fake database entries. These synthetic entries appear as valid customer data but are entirely fictional.
4. Active Misdirection: The security system dynamically redirects the attacker's SQL injection query to the synthetic database entries instead of the real database. The attacker believes they are successfully extracting sensitive customer information.
5. Attacker Interaction: Unaware of the active misdirection, the attacker continues to send SQL injection queries, believing they are accessing genuine customer data.
6. Detection and Analysis: The security system closely monitors the attacker's actions within the synthetic database environment. Any suspicious or repeated queries trigger additional analysis.
7. Countermeasures and Attribution: As the attacker interacts with synthetic data, the security team collects valuable information about their tactics and identifies potential indicators of compromise (IoCs). They also trace the attacker's origin based on IP addresses.
8. Blocking and Reporting: Using the gathered information, the security team takes immediate actions to block the attacker's IP address and strengthen security measures. They report the incident to relevant authorities if necessary.
9. Enhanced Security and Patching: The insights gained from the attacker's actions are used to improve website security, including patching vulnerabilities and fine-tuning intrusion detection systems.
10. Preventive Measures: The company implements preventive measures, such as web application firewalls and regular security audits, to reduce the risk of future attacks.

In the above realistic scenario, the synthetic data is employed to actively misdirect the attacker during the SQL injection attack. The use of synthetic data not only thwarts the attacker's efforts but also provides the security team with crucial insights for mitigation and prevention of future cyber threats.

The dynamic countermeasure controller (140) may implement analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes with respect to the present disclosure. The communicator (120) is configured for communicating internally between internal hardware components and with external devices via one or more networks. Further, the memory (130) stores the fraudulent activity embedded in the data item. The memory (130) also stores instructions to be executed by the processor (110). The memory (130) may include non-volatile storage elements. Examples of such non-volatile storage elements may include magnetic hard disks, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Further, at least one of the plurality of modules/controllers may be implemented through the AI model/ML model using the data driven controller (150). The data driven controller (150) can be an ML or AI model-based controller. A function associated with the AI model may be performed through the non-volatile memory, the volatile memory, and the processor (110). The processor (110) may include one or a plurality of processors. The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to the present invention is performed, and/or may be implemented through a separate server/system.

The AI model may comprise a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning technique include, but are not limited to, supervised learning, unsupervised learning, semi-supervised learning, or reinforcement learning.

Although FIG. 1 shows various hardware components of the electronic device (100) but it is to be understood that other embodiments are not limited thereon. In other embodiments, the electronic device (100) may include less or more number of components. Further, the labels or names of the components are used only for illustrative purposes and do not limit the scope of the invention. One or more components can be combined together to perform the same or substantially similar function in the electronic device (100).

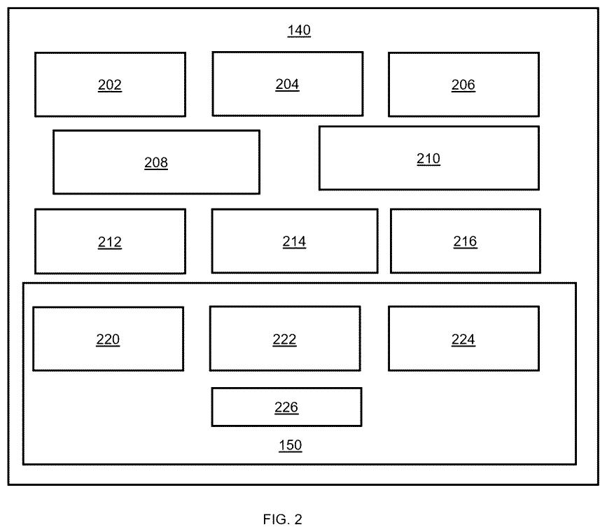

FIG. 2 shows various hardware components of the dynamic countermeasure controller (140) included in the electronic device (100). In an embodiment, the dynamic countermeasure controller (140) includes an anomaly detection engine (202), a deceptive generative engine (204), an adversarial feedback engine (206) (aka “real-time feedback engine”), an autonomous and adaptive countermeasure engine (208), a counter-attack simulation engine (210), a synthetic incident generation engine (212), an automated fraud response scenario generation engine (214), a dynamic honeypot engine (216) and the data driven controller (150). The data driven controller (150) includes a GAN (220), an auxiliary classifier (222), a recurrent neural network (224) and a Long Short-Term Memory (LSTM) unit (226).

While handling the disruptive action during the anomaly detection, the anomaly detection engine (202), the deceptive generative engine (204), the adversarial feedback engine (206), the autonomous and adaptive countermeasure engine (208), the counter-attack simulation engine (210), the synthetic incident generation engine (212), the automated fraud response scenario generation engine (214), the dynamic honeypot engine (216) and the data driven controller (150) are in active state and engaged in continuous learning, adapting its deception strategies, countermeasures, and response scenarios for providing the responsive and proactive fraud prevention.

In an embodiment, the anomaly detection engine (202) monitors the user activity for the potential fraud attempt using the anomaly detection mechanism. Upon monitoring, the deceptive generative engine (204) continuously generates the synthetic data with the self-evolving deception strategy. The self-evolving deception strategy is adapted to emerge the threat pattern and introduce the intentional inconsistency to misguide the potential attacker while attempting the potential fraud. Further, the self-evolving deception strategy dynamically adjusts the generation of the synthetic data to actively misguide the potential attacker.

The anomaly detection engine (202) may implement analog and/or digital circuits such as logic gates, integrated circuits, microprocessors, microcontrollers, memory circuits, passive electronic components, active electronic components, optical components, hardwired circuits and the like, and may optionally be driven by firmware.

Further, the adversarial feedback engine (206) may be placed between the deceptive generative engine (204) and the anomaly detection engine (202) to ensure the real-time assessment and immediate adjustments to the deception strategies. This contributes to the system's adaptability and effectiveness. Further, the adversarial feedback engine (206) evaluates the effectiveness of the self-evolving deception strategy in real-time. Based on the evaluation over the period of time, the adversarial feedback engine (206) provides the feedback to the dynamic countermeasure controller (140) for adaptive adjustments of the self-evolving deception strategy.

The adversarial feedback engine (206) may implement analog and/or digital circuits such as logic gates, integrated circuits, microprocessors, microcontrollers, memory circuits, passive electronic components, active electronic components, optical components, hardwired circuits and the like, and may optionally be driven by firmware.

Further, the autonomous and adaptive countermeasure engine (208) identifies the anomaly based on the comparison between the real time data and the synthetic data. Further, the autonomous and adaptive countermeasure engine (208) initiates the disruptive action for autonomously responding to the identified anomaly. The predefined disruptive action autonomously responds to the identified anomaly using the data driven controller (150).

Further, the autonomous and adaptive countermeasure engine (208) is operating as decentralized entity capable of autonomously responding to identified anomalies. The autonomous and adaptive countermeasure engine (208) leverages machine learning and decision-making technique to dynamically disrupt fraudulent activities. The autonomous and adaptive countermeasure engine (208) provides the dynamic disruption mechanism. The dynamic disruption mechanism can be, for example, but not limited to an active misdirection-based mechanism and an automated response-based mechanism.

In the active misdirection-based mechanism, the autonomous and adaptive countermeasure engine (208) actively misdirects the potential attackers by generating the synthetic data that deliberately introduces inconsistencies and false patterns. The misdirection disrupts the attackers'ability to discern a normal data from the synthetic data. In the automated response based-mechanism, the autonomous and adaptive countermeasure engine (208) autonomously responds to anomalies by initiating the pre-defined disruptive actions. The pre-defined disruptive actions can be, for example, but not limited to isolating suspicious users, blocking transactions, or dynamically modifying access controls to impede malicious activities.

In an example, the autonomous and adaptive countermeasure engine (208) incorporates the GAN (220) with a conditional GAN setup trained on the historical attack data. The counter-attack simulation engine (210) uses the latent variables to simulate potential future attack scenarios. The GAN (220) adapts its learning rates based on real-time threat assessments to ensure dynamic adjustments to response strategies. In other words, the autonomous and adaptive countermeasure engine (208) act as a decentralized entity with machine learning technique and provides a predefined disruptive action so as to enable a dynamic and distributed approach to responding to identified anomalies.

Below is the example execution explained with respect to the learning rates:
1. Initial Training Phase: During the initial setup, the GAN (220) within the autonomous and adaptive countermeasure engine (208) is trained on the historical attack data. The conditional GAN setup ensures that the generated data corresponds to various types of attacks and their characteristics.
2. Identification of Latent Variables: The electronic device (100) identifies latent variables that are correlated with specific attack behaviours. For instance, the latent variable related to “stealthy reconnaissance” is discovered through statistical analysis of historical attack data.
3. Real-time Threat Assessment: As the electronic device (100) operates, the real-time threat assessment module continuously monitors network activity. It recognizes patterns and behaviours that may indicate the presence of an APT or similar threat.
4. Latent Variable Integration: When a potential threat is detected, the electronic device (100) analyses the current network state along with the identified latent variables. For instance, if the latent variable related to “stealthy reconnaissance” is present in the real-time data, it suggests that the attackers may be conducting reconnaissance activities.
5. Dynamic Countermeasure Adjustment: The GAN (220) adapts its learning rates based on the assessment of the current threat level. If the electronic device (100) detects an increase in reconnaissance activities, it triggers the GAN to adjust its learning rates dynamically.
6. Counter-Attack Simulation: Using the latent variables, the counter-attack simulation engine (210) simulates potential future attack scenarios that align with the observed threat indicators. These simulated scenarios help the electronic device (100) evaluates and refine countermeasures.
7. Adaptive Countermeasures: The electronic device (100) generates adaptive countermeasures in response to the identified threat indicators. For example, it might deploy enhanced network monitoring, isolate suspicious segments of the network, and initiate user behaviour analysis.
8. Continuous Learning: The electronic device (100) continuously adapts and learns from ongoing threats and response outcomes. This ensures that the GAN (220) and latent variables remain effective in identifying and countering evolving APT tactics.

Below is the detailed example of how the learning rates of the GAN (220) can be dynamically adjusted based on the assessment of the current threat level in the context of cybersecurity: Below are the example execution explained for the adaptive learning for GAN in Cybersecurity:
1. Initial Learning Rates Setup: When the electronic device (100) is initially deployed, the GAN is configured with default learning rates for its generator and discriminator networks. These rates determine the speed at which the GAN adapts to new data.
2. Normal Network Operation: During normal network operation, the real-time threat assessment module monitors network traffic and behaviours. The GAN operates with its default learning rates.
3. Increase in Reconnaissance Activities: Suppose the real-time threat assessment module detects an unusual increase in reconnaissance activities, such as multiple suspicious port scans, unusual data retrieval, or repeated login attempts from unfamiliar IP addresses.
4. Threat Assessment: The electronic device (100) assesses the threat level based on the observed increase in reconnaissance activities. It determines that the network is potentially under an advanced reconnaissance phase by malicious actors.
5. Dynamic Learning Rate Adjustment: In response to the increased threat level, the electronic device (100) triggers the GAN to dynamically adjust its learning rates such as generator learning rate and discriminator learning rate
   i. Generator Learning Rate: The learning rate for the generator network is increased. A higher learning rate makes the generator adapt more quickly to generate synthetic data that can mimic the reconnaissance patterns observed in the network.
   ii. Discriminator Learning Rate: The learning rate for the discriminator network may be decreased slightly. This makes the discriminator more cautious in distinguishing between real and synthetic data, allowing the generator to catch up in mimicking the reconnaissance behaviour.
6. Adaptive Data Generation: With the adjusted learning rates, the GAN starts generating synthetic data that better captures the observed reconnaissance patterns. This synthetic data is then used for anomaly detection and response.
7. Countermeasures Activation: Simultaneously, the electronic device (100) activates countermeasures such as increased network monitoring, automated responses to suspicious activities, and alerts to security personnel.
8. Continuous Monitoring: The electronic device (100) continues to monitor network activities in real-time. As the reconnaissance phase evolves or subsides, the threat level may change.
9. Learning Rate Re-evaluation: Periodically, the electronic device (100) re-evaluates the threat level based on ongoing network behaviour. If the threat decreases and reconnaissance activities normalize, the electronic device (100) may gradually revert the GAN's learning rates to their default settings to balance generative and discriminative capabilities.
10. Continuous Adaptation: The electronic device (100) maintains continuous adaptation based on the dynamic threat assessment, ensuring that the GAN's learning rates remain synchronized with the evolving threat landscape.

The autonomous and adaptive countermeasure engine (208) may implement analog and/or digital circuits such as logic gates, integrated circuits, microprocessors, microcontrollers, memory circuits, passive electronic components, active electronic components, optical components, hardwired circuits and the like, and may optionally be driven by firmware.

In another embodiment, the anomaly detection engine (202) continuously monitors the user activity for the potential fraud attempt using the anomaly detection mechanism. Further, the deceptive generative engine (204) dynamically generates the deceptive element to mislead and misguide the potential attacker upon detection of the potential fraud attempt.

In an example, the deceptive generative engine (204) employs the GAN (220), such as a Wasserstein GAN or the like, trained on the historical attack data to generate the synthetic user profiles, the transactions, or the system interactions. The GAN utilizes a multi-layered generator network with adaptive learning rates to ensure effective deception.

Further, the counter-attack simulation engine (210) generates and deploys the adaptive countermeasure based on the known attack pattern and the detected attack pattern using the generated deceptive element. In an example, the counter-attack simulation engine (210) integrates the GAN (220) with the auxiliary classifier (222) trained on the dataset of known attack patterns. The GAN (220) generates the potential counter-attack strategies for the proactive defence. The adversarial training is employed to enhance the GAN's capability to generate realistic and effective counter-attack simulations.

The counter-attack simulation engine (210) may implement analog and/or digital circuits such as logic gates, integrated circuits, microprocessors, microcontrollers, memory circuits, passive electronic components, active electronic components, optical components, hardwired circuits and the like, and may optionally be driven by firmware.

Further, the synthetic incident generation engine (212) generates the disruptive action upon determining the fraud pattern. In an embodiment, the synthetic incident generation engine (212) performs at least one of: simulate the potential counter-attack and the response to deter and disrupt the attacker. In an example, the synthetic incident generation engine (212) utilizes the GAN (220) with the recurrent neural network (224) trained on the historical incident response data. The synthetic incident generation engine (212) generates the detailed incident reports including information on the attack, its impact, and recommended response actions. The LSTM (Long Short-Term Memory) cells (226) are employed within the GAN (220) to capture temporal dependencies in incident response data.

The synthetic incident generation engine (212) may implement analog and/or digital circuits such as logic gates, integrated circuits, microprocessors, microcontrollers, memory circuits, passive electronic components, active electronic components, optical components, hardwired circuits and the like, and may optionally be driven by firmware.

Further, the automated fraud response scenario generation engine (214) creates the synthetic incident report. The synthetic incident report includes detailed information on the detected fraud attempt and recommended response action. Further, the automated fraud response scenario generation engine (214) generates the response scenario based on the created synthetic incident report, the potential counter-attack and the response to deter and disrupt the attacker. In an example, the automated fraud response scenario generation engine (214) incorporates the GAN (220) with attention mechanisms (not shown) trained on the diverse dataset of fraud patterns and response actions. The GAN (220) understands relationships between detected anomalies and response actions, so as to facilitate the automated scenario generation for efficient fraud response. The attention mechanisms ensure that the GAN focuses on relevant features in the fraud patterns and response data.

The automated fraud response scenario generation engine (214) may implement analog and/or digital circuits such as logic gates, integrated circuits, microprocessors, microcontrollers, memory circuits, passive electronic components, active electronic components, optical components, hardwired circuits and the like, and may optionally be driven by firmware.

The dynamic honeypot engine (216) is configured to create dynamic honeypots that divert and capture information about attackers. The dynamic honeypot engine (216) integrates the GAN (220) with a generative LSTM architecture (not shown) trained to generate synthetic system vulnerabilities. These vulnerabilities are deployed as dynamic honeypots to divert and capture information about attackers. Generative LSTM cells enhance the GAN's ability to capture sequential dependencies in system vulnerability data.

The dynamic honeypot engine (216) may implement analog and/or digital circuits such as logic gates, integrated circuits, microprocessors, microcontrollers, memory circuits, passive electronic components, active electronic components, optical components, hardwired circuits and the like, and may optionally be driven by firmware.

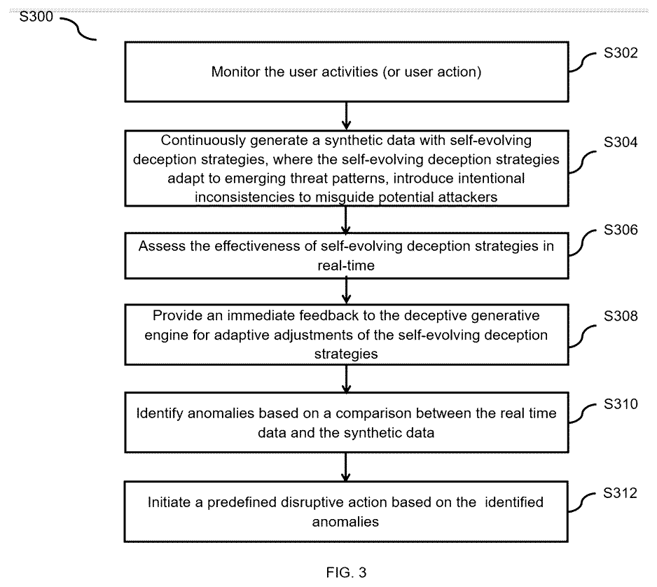

FIG. 3, FIG. 4A and FIG. 4B are flow charts (S300 and S400) illustrating a method for handling a disruptive action during an anomaly detection.

As shown in FIG. 3, at S302, the method includes monitoring the user activities (or the user action). In an embodiment, the method allows the anomaly detection engine (202) to monitor the user activities (or user action).

At S304, the method includes continuously generating the synthetic data with the self-evolving deception strategies. The self-evolving deception strategies adapt to emerging threat patterns and introduce intentional inconsistencies to misguide potential attackers. In an embodiment, the method allows the deceptive generative engine (204) to continuously generate the synthetic data with self-evolving deception strategies.

At S306, the method includes assessing the effectiveness of the self-evolving deception strategies in the real-time. In an embodiment, the method allows the adversarial feedback engine (206) to assess the effectiveness of self-evolving deception strategies in the real-time.

At S308, the method includes providing the immediate feedback to the deceptive generative engine (204) for adaptive adjustments of the self-evolving deception strategies. In an embodiment, the method allows the adversarial feedback engine (206) to provide the immediate feedback to the deceptive generative engine (204) for adaptive adjustments of the self-evolving deception strategies.

At S310, the method includes identifying the anomalies based on the comparison between the real time data and the synthetic data. In an embodiment, the method allows the anomaly detection engine (202) to identify the anomalies based on the comparison between the real time data and the synthetic data.

At S312, the method includes initiating the predefined disruptive action based on the identified anomalies. In an embodiment, the method allows the autonomous and adaptive countermeasure engine (208) to initiate the predefined disruptive action based on the identified anomalies.

As shown in FIG. 4A and FIG. 4B, At S402, the method includes continuously monitoring the user activities (user action) for potential fraud attempts using the anomaly detection mechanism. In an embodiment, the method allows the anomaly detection engine (202) to continuously monitor the user activities (or the user action) for the potential fraud attempts using the anomaly detection mechanism.

At S404, the method includes dynamically generating the deceptive element to confuse and misguide attackers upon detection of the fraud attempt. In an embodiment, the method allows deceptive generative engine (204) to dynamically generate the deceptive element to confuse and misguide the attackers upon detection of the fraud attempt.

At S406, the method includes generating and deploying the adaptive countermeasures based on known and detected attack patterns. In an embodiment, the method allows the autonomous and adaptive countermeasure engine (208) to generate and deploy the adaptive countermeasures based on the known and detected attack patterns.

At S408, the method includes simulating the potential counter-attacks or response to further deter and disrupt attackers. In an embodiment, the method allows the counter-Attack simulation engine (210) to simulate the potential counter-attacks or response to further deter and disrupt attackers.

At S410, the method includes creating the synthetic incident reports and providing the detailed information on the detected fraud attempt and recommended response actions. In an embodiment, the method allows the synthetic incident generation engine (212) to create the synthetic incident reports and provide detailed information on the detected fraud attempt and recommended response actions.

At S412, the method includes generating the response scenarios based on the detected fraud patterns and ensuring swift and effective responses. In an embodiment, the method allows the automated fraud response scenario generation engine (214) to automatically generate the response scenarios based on the detected fraud patterns and ensuring the swift and effective responses.

At S414, the method includes deploying the dynamic honeypots, divert and capture information about the attackers for further analysis. In an embodiment, the method allows the dynamic honeypot engine (216) to deploy the dynamic honeypots, divert and capture information about the attackers for further analysis.

The various actions, acts, blocks, steps, or the like in the flow chart (S300 and S400) may be performed in the order presented, in a different order or simultaneously. Further, in some implementations, some of the actions, acts, blocks, steps, or the like may be omitted, added, modified, skipped, or the like without departing from the scope of the invention.

The embodiments disclosed herein can be implemented using at least one software program running on at least one hardware device and performing network management functions to control the elements.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope of the invention. It is intended that the specification and examples be considered as exemplary, with the true scope of the invention being indicated by the claims.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware.

The results of the disclosed methods may be stored in any type of computer data repository, such as relational databases and flat file systems that use volatile and/or non-volatile memory (e.g., magnetic disk storage, optical storage, EEPROM and/or solid-state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain alternative include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain alternatives require at least one of X, at least one of Y, or at least one of Z to each be present.

While the detailed description has shown, described, and pointed out novel features as applied to various alternatives, it can be understood that various omissions, substitutions, and changes in the form and details of the devices or algorithms illustrated can be made without departing from the scope of the disclosure. As can be recognized, certain alternatives described herein can be embodied within a form that does not provide all of the features and benefits set forth herein, as some features can be used or practiced separately from others.

What is claimed is:

1. An electronic device for handling a disruptive action during an anomaly detection, comprising:
a processor;
a memory; and
a dynamic countermeasure controller, coupled to the processor and the memory, configured to:
monitor at least one user activity for at least one potential fraud attempt using an anomaly detection mechanism;
continuously generate a synthetic data with a self-evolving deception strategy upon monitoring, where the self-evolving deception strategy is adapted to emerge a threat pattern and introduce an intentional inconsistency to misguide a potential attacker while attempting the at least one potential fraud;
evaluate effectiveness of the self-evolving deception strategy in real-time;
provide a feedback to the dynamic countermeasure controller for adaptive adjustments of the self-evolving deception strategy based on the evaluation over a period of time;
identify an anomaly based on a comparison between a real time data and the synthetic data; and
initiate the disruptive action for autonomously responding to the identified anomaly.

2. The electronic device as claimed in claim 1, wherein the self-evolving deception strategy dynamically adjusts the generation of the synthetic data to actively misguide the potential attacker.

3. The electronic device as claimed in claim 1, wherein the predefined disruptive action autonomously responds to the identified anomaly using a data driven model, wherein the pre-defined disruptive action corresponds to isolate a suspicious user, block a potentially fraudulent transaction, and dynamically modify access controls to impede malicious activity.

4. The electronic device as claimed in claim 1, wherein the potential attacker is misdirected by generating the synthetic data that deliberately introduces inconsistencies and false patterns, and disrupting the attackers'ability to discern normal from the synthetic data.

5. An electronic device for handling a disruptive action during an anomaly detection, comprising:
a processor;
a memory; and
a dynamic countermeasure controller, coupled to the processor and the memory, configured to:
continuously monitor at least one user activity for at least one potential fraud attempt using an anomaly detection mechanism;
dynamically generate a deceptive element to mislead and misguide a potential attacker upon detection of the at least one potential fraud attempt;
generate and deploy at least one adaptive countermeasure based on a known attack pattern and a detected attack pattern using the generated deceptive element; and
generate the disruptive action upon determining at least one fraud pattern.

6. The electronic device as claimed in claim 5, wherein generate the disruptive action upon determining the at least one fraud pattern comprising:
perform at least one of: simulate a potential counter-attack and a response to deter and disrupt the attacker;
create a synthetic incident report, wherein the synthetic incident report comprises detailed information on the detected fraud attempt and recommended response action; and
generate the response scenario based on the created synthetic incident report, the potential counter-attack and the response to deter and disrupt the attacker.

7. The electronic device as claimed in claim 5, wherein the deceptive element is dynamically generated by:
training a plurality of historical attack data to generate at least one of: a synthetic user profile, a transaction, and a system interaction using a data driven controller; and
dynamically generating the deceptive element comprising at least one of: the synthetic user profile, the transaction, and the system interaction.

8. The electronic device as claimed in claim 5, wherein the at least one adaptive countermeasure is generated by:
training a plurality of historical attack data comprising a latent variable to simulate potential future attack scenario using a data driven controller; and
generating the at least one adaptive countermeasure based on the training over the period of time.

9. The electronic device as claimed in claim 5, wherein the disruptive action is generated by:
training a dataset of fraud patterns and response actions using a data driven controller;
identifying a relationship between the detected anomaly and the response actions; and
facilitating a generation of disruptive action.

10. The electronic device (100) as claimed in claim 6, wherein the potential counter-attack is simulated by training a dataset of known attack patterns using a data driven controller.

11. The electronic device (100) as claimed in claim 6, wherein the response to deter and disrupt the attacker is generated by training a plurality of synthetic system vulnerabilities using a data driven controller.

12. A method for handling a disruptive action during an anomaly detection, comprising:
monitoring, by an electronic device, at least one user activity for at least one potential fraud attempt using an anomaly detection mechanism;
continuously generating, by the electronic device, a synthetic data with a self-evolving deception strategy upon monitoring, where the self-evolving deception strategy is adapted to emerge a threat pattern and introduce an intentional inconsistency to misguide a potential attacked while attempting the at least one potential fraud;
evaluating, by the electronic device, effectiveness of the self-evolving deception strategy in real-time;
providing, by the electronic device, a feedback to the electronic device for adaptive adjustments of the self-evolving deception strategy based on the evaluation over a period of time;
identifying, by the electronic device, an anomaly based on a comparison between a real time data and the synthetic data; and
initiating, by the electronic device, the disruptive action for autonomously responding to the identified anomaly.

13. The method as claimed in claim 12, wherein the self-evolving deception strategy dynamically adjusts the generation of the synthetic data to actively misguide the potential attacker.

14. The method as claimed in claim 12, wherein the predefined disruptive action autonomously responds to the identified anomaly using a data driven model, wherein the pre-defined disruptive action corresponds to isolate a suspicious user, block a potentially fraudulent transaction, and dynamically modify access controls to impede malicious activity.

15. The method as claimed in claim 12, wherein the potential attacker is misdirected by generating the synthetic data that deliberately introduces inconsistencies and false patterns, and disrupting the attackers'ability to discern normal from the synthetic data.

16. A method for handling a disruptive action during an anomaly detection, comprising:
continuously monitoring, by an electronic device, at least one user activity for at least one potential fraud attempt using an anomaly detection mechanism;
dynamically generating, by the electronic device, a deceptive element to mislead and misguide a potential attacker upon detection of the at least one potential fraud attempt;
generating and deploying, by the electronic device, at least one adaptive countermeasure based on a known attack pattern and a detected attack pattern using the generated deceptive element; and
generating, by the electronic device, the disruptive action upon determining at least one fraud pattern.

17. The method as claimed in claim 16, wherein generating the disruptive action upon determining the at least one fraud pattern comprising:
performing at least one of: simulating a potential counter-attack and responding to deter and disrupt the attacker;
creating a synthetic incident report, wherein the synthetic incident report comprises detailed information on the detected fraud attempt and recommended response action; and
generating the response scenario based on the created synthetic incident report, the potential counter-attack and the response to deter and disrupt the attacker.

18. The method as claimed in claim 16, wherein the deceptive element is dynamically generated by:
training a plurality of historical attack data to generate at least one of: a synthetic user profile, a transaction, and a system interaction using a data driven controller; and
dynamically generating the deceptive element comprising at least one of: the synthetic user profile, the transaction, and the system interaction.

19. The method as claimed in claim 16, wherein the at least one adaptive countermeasure is generated by:
training a plurality of historical attack data comprising a latent variable to simulate potential future attack scenario using a data driven controller;
generating the at least one adaptive countermeasure based on the training over the period of time.

20. The method as claimed in claim 16, wherein the disruptive action is generated by:
training a dataset of fraud patterns and response actions using a data driven controller;
identifying a relationship between the detected anomaly and the response actions; and
facilitating a generation of disruptive action.

21. The method as claimed in claim 17, wherein the potential counter-attack is simulated by training a dataset of known attack patterns using a data driven controller.

22. The method as claimed in claim 17, wherein the response to deter and disrupt the attacker is generated by training a plurality of synthetic system vulnerabilities using a data driven controller.
